(19) United States
(12) Patent Application Publication
(10) Pub. No.: US 2009/0058916 A1
(43) Pub. Date: Mar. 5, 2009

(54) IMAGE FORMING METHOD AND IMAGE FORMING APPARATUS

(75) Inventor: Shigeo Kuroda, Moriya-shi (JP)

Correspondence Address: FITZPATRICK CELLA HARPER & SCINTO, 30 ROCKEFELLER PLAZA, NEW YORK, NY, 10112, US

(73) Assignee: CANON FINETECH INC., Misato-shi (JP)

(21) Appl. No.: 12/197,647

(22) Filed: Aug. 25, 2008

(30) Foreign Application Priority Data
Aug. 30, 2007 (JP) 2007-223880
Jul. 7, 2008 (JP) 2008-176711

(51) Int. Cl. B41J 29/38

(52) U.S. Cl. 347/17

(57) ABSTRACT

Provided is an image forming method which prevents the temperatures of printing heads from exceeding a predetermined temperature. In this image forming method, its basic assignment is changed when any one of the temperatures detected by the respective temperature sensors exceeds the predetermined temperature (for example, 60° C.). Specifically, each time the forming of an image on a printing medium (for example, a label) is completed, the temperatures of the respective printing heads are detected with the respective temperature sensors. When any one of the temperatures thus detected exceeds 60° C., the association of raster line regions with ink ejection opening arrays (the association of rasters with the printing heads) under the basic assignment is shifted one-by-one.

### BACKGROUND OF THE INVENTION

1. Field of the Invention

The present invention relates to an image forming method and an image forming apparatus for forming an image on a printing medium by ejecting ink onto the printing medium.

2. Description of the Related Art

Dry-type electro-photographic printers have been heretofore used to print business forms and the like. Recently, replacing the dry-type electro-photographic printers, inkjet printers (inkjet image forming apparatuses) started to be used. This inkjet image forming apparatus forms an image on a printing medium by ejecting ink droplets onto the printing medium from multiple ink ejection openings (nozzle ports) formed in its printing head. One of known technologies for ejecting ink droplets is a technology for ejecting ink droplets from nozzles by use of bubbles formed in ink in the nozzles by film boiling, by supplying the ink with thermal energy depending on driving pulses. Thereby, multiple ink droplets depending on an image to be formed are ejected onto a printing medium from the nozzles to form the image.

Generally, each of such inkjet printers performs direct printing (forms an image) on a roll of paper, and is thus capable of processing a large amount of printing work. In addition, its running costs are economical. For this reason, such inkjet printers are suitable for printing various types of business forms including application forms for insurances, invoice forms of public utility charges, and application forms for mail-order sales. Nevertheless, the inkjet printers are incapable of performing printing at a printing speed exceeding a maximum driving frequency of a printing head itself (a maximum nominal value of the number of times per second that the printing head repeatedly ejects ink while keeping a stable image quality: Hz). This brings about a problem that the inkjet printers cannot fully meet a demand from the market that their printing speeds be increased. For the purpose of solving such a problem, a proposal has been made for “raster division” for increasing a printing speed by performing printing by use of what is termed as a line printer. In the case of the raster division, data on a single color image is subjected to raster development so as to generate raster data, and the raster data is divided into multiple data sets. Then, the printing is performed by assigning the multiple data sets respectively to multiple printing heads of the line printer (see Japanese Patent Laid-open No. 2005-238556, for example).

Many of the above-mentioned line printers use printing heads in each of which an ink ejection opening array is formed, and the ink ejection opening array is made of multiple ink ejection openings arranged in a direction orthogonal to a printing medium conveying direction (that is an example of an intersection direction in the present invention). Referring to FIGS. 9A, 9B and 10, descriptions will be provided for how an image is formed by use of, for example, four such printing heads (corresponding to four ink ejection opening arrays, and constituting an example of a multiple array arrangement as recited in the present invention) arranged in the printing medium conveying direction.

FIG. 9A is a schematic diagram showing four printing heads K1, K2, K3 and K4 arranged in the printing medium conveying direction (in an arrow A direction). FIG. 9B is a schematic diagram showing ink droplets which land on a printing medium from the printing heads K1, K2, K3 and K4. FIG. 10 is a schematic diagram showing how the same ruler lines K are repeatedly printed on printing media P. In this respect, let us assume that the four printing heads K1, K2, K3 and K4 are sequentially arranged from upstream to downstream in the printing media conveying direction, and perform printing in this order. In FIG. 9A, circled reference numerals denote array numbers respectively assigned to the ink ejection opening arrays of the printing heads. In FIG. 9B, each circled area denotes a pixel region and, circled reference numerals correspond to the array numbers and denote what ink ejection opening arrays formed the pixels. Furthermore, in FIG. 9B, the long dashed double-short dashed lines demarcate raster line regions which will be described later, and a region interposed between each two neighboring long dashed double-short dashed lines is a raster line region according to the present invention.

After printing is performed with the printing heads K1, K2, K3 and K4 in this sequence once, printing is performed with the printing head K1 again following the printing with the printing head K4, as shown in FIG. 10. An area from a printing region (a raster line region) of the printing head K1 to a printing region of the printing head K4 is printed while conveying the printing medium by a distance corresponding to an interval at which the printing heads K1 to K4 are arranged. Timings at which the printing is performed by the respective printing heads K1, K2, K3 and K4 can be adjusted by checking an image printed on the printing medium. For this reason, various proposals have been made on the method of correcting an error which may occur due to the printing heads.

In a case where standardized forms such as business forms are printed by use of a line printer of the above-described type, as shown in FIG. 10, the same ruler lines K are repeatedly printed on respective pages (exemplified as pages 1 to 4 shown in FIG. 10) of a printing media sheet P such as paper, and a large amount of forms are often printed. In this case, image data carrying the ruler line K is printed by subjecting the image data to raster development to obtain raster data, subsequently by dividing the raster data into data sets, and thereafter by assigning the data sets to the printing heads K1 to K4. This type of printing operation uses a particular printing head (for example, the printing head K1 in the case shown in FIG. 10) overwhelmingly more than the other printing heads, and hence raises the temperature (head temperature) of the particular printing head (for example, the printing head K1). The head temperature is one of the parameters for determining the amount of ejected ink. This point will be described by referring to FIG. 11, FIG. 11 is a graph showing a relationship between the head temperature and the amount of ejected ink.

In a case where, as shown in FIG. 11, the amount of ejected ink increases as the temperature of the printing head rises, the image quality deteriorates. For this reason, by changing the widths of pulses, the amount of ejected ink is prevented from increasing and decreasing due to the change in the head temperature. In spite of this, it is difficult to control the amount of ejected ink when the temperature of the printing head reaches or exceeds a predetermined temperature (for example, when the temperature of the printing head reaches or exceeds 60° C. as shown in FIG. 11). This brings about a problem that it is hard to obtain a stable image.

### SUMMARY OF THE INVENTION

With the foregoing situation taken into consideration, an object of the present invention is to provide an image forming method and an image forming apparatus both which prevent a head temperature from reaching or exceeding a predetermined temperature.

In a first aspect of the present invention, there is provided an image forming method of forming an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being arranged one after another in the printing medium conveying direction, each ink ejection opening array including a plurality of ink ejection openings arranged in the intersection direction, comprising the steps of:

setting up a basic assignment beforehand determining which one of the plurality of ink ejection opening arrays be assigned to each of the raster line regions on the printing medium so that the ink is ejected from the assigned ink ejection opening array to the assigned raster line region;

detecting temperatures respectively of the plurality of ink ejection opening arrays while the image is being formed; and

based on the temperatures thus detected, changing the basic assignment.

In a second aspect of the present invention, there is provided an image forming apparatus that forms an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being arranged one after another in the printing medium conveying direction, each ink ejection opening array including a plurality of ink ejection openings arranged in the intersection direction, comprising the steps of:

a setting up unit which sets up a basic assignment beforehand determining which one of the plurality of ink ejection opening arrays be assigned to each of the raster line regions on the printing medium so that the ink is ejected from the assigned ink ejection opening array to the assigned raster line region;

a detecting unit which detects temperatures respectively of the plurality of ink ejection opening arrays while the image is being formed; and

a basic assignment changing unit which changes the basic assignment based on the temperatures detected by the detection unit.

In a third aspect of the present invention, there is provided an image forming method of forming an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being arranged one after another in the printing medium conveying direction, each ink ejection opening array including a plurality of ink ejection openings arranged in the intersection direction, comprising the steps of:

setting up a basic assignment beforehand determining which one of the plurality of ink ejection opening arrays be assigned to each of the raster line regions on the printing medium so that the ink is ejected from the assigned ink ejection opening array to the assigned raster line region:

estimating of how much temperatures of the respective ink ejection opening arrays; and

based on the temperatures thus estimated, changing the basic assignment.

The present invention makes it possible to change a basic assignment (a predetermined assignment of sets of raster data to their respective printing heads) on the basis of the temperatures of the ink ejection opening arrays while forming an image. Thus, when the temperature of an ink ejection opening array is detected being higher than a predetermined temperature, the present invention makes it possible to change the basic assignment in such a way as to stop ink from being ejected (or to reduce the amount of ink to be ejected) from the ink ejection opening array. As a result, the amount of ink ejected from the ink ejection opening array thus detected decreases, and the temperature of the ink ejection opening array accordingly becomes lower. Because, as described above, the basic assignment is designed to be changed in such a way as to stop ink from being ejected (or to reduce the amount of ink to be ejected) from any ink ejection opening array whose temperature exceeds the predetermined temperature, the temperatures of the respective ink ejection opening arrays no longer rise to, or exceed, the predetermined temperature. For this reason, the present invention makes it possible to prevent the image quality from deteriorating due to increase in the temperatures of the ink ejection opening arrays, and thus to stabilize the printing quality.

Further features of the present invention will become apparent from the following description of exemplary embodiments (with reference to the attached drawings).

### BRIEF DESCRIPTION OF THE DRAWINGS

FIG. 1 is a perspective view showing a schematic of a line printer as an example of an image forming apparatus according to the present invention;

FIG. 2 is a block diagram showing an example of a configuration of a control system of the printer shown in FIG. 1;

FIG. 3 is a flowchart showing the relationship of FIGS. 3A and 3B;

FIG. 3A is a flowchart showing a first embodiment of an image forming method according to the present invention;

FIG. 3B is a flowchart showing a first embodiment of an image forming method according to the present invention;

FIG. 4 is a flowchart showing a second embodiment of the image forming method according to the present invention;

FIG. 5 is a perspective view showing a printing head K in which multiple ink ejection opening arrays (nozzle arrays) N1, N2, N3 and N4 are formed;

FIG. 6 is a flowchart showing a main part of a third embodiment obtained by providing the first embodiment with a function of operating with a difference in temperature among printing heads taken into consideration;

FIG. 7 is a graph showing how the temperature of a printing head rises depending on the number of continuously-printed labels. In the graph, the horizontal axis indicates the number of continuously-printed labels, and the vertical axis indicates the temperature of the printing head;

FIG. 8 is a flowchart showing an example of the image forming method according to the present invention;

FIG. 9A is a schematic diagram showing four printing heads K1, K2, K3 and K4 arranged in a direction in which a printing medium is conveyed (or in an arrow A direction);

FIG. 9B is a schematic diagram showing ink droplets which land on the printing medium from the printing heads K1, K2, K3 and K4;

FIG. 10 is a schematic diagram showing how the same ruler lines K are repeatedly printed on a printing medium P; and

FIG. 11 is a graph showing a relationship between the temperature of a printing head and the amount of ejected ink. In the graph, the horizontal axis indicates the temperature of the printing head, and the vertical axis indicates the amount of the ejected ink.

### DESCRIPTION OF THE EMBODIMENTS

The present invention is embodied as a line printer including four printing heads used for a single color.

### First Embodiment

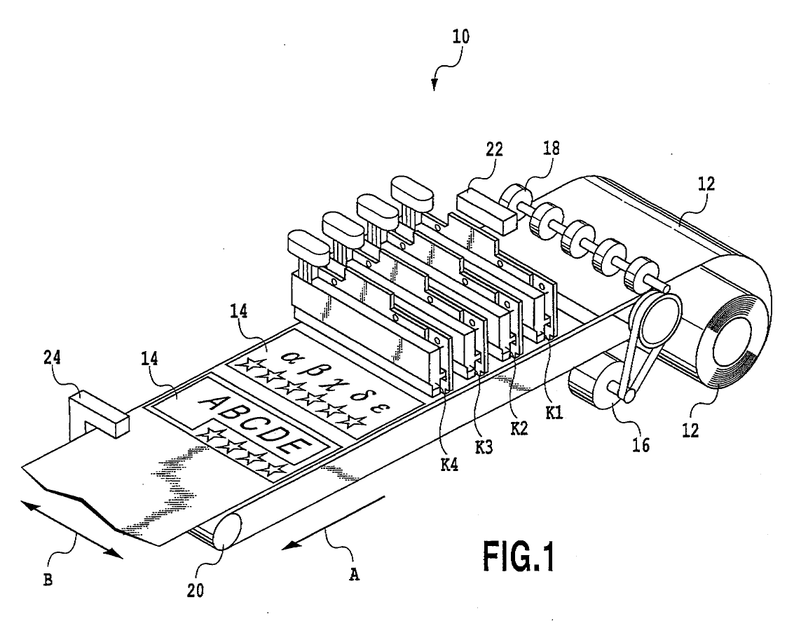

Referring to FIG. 1, descriptions will be provided for an example of an image forming apparatus according to the present invention.

FIG. 1 is a perspective view showing a schematic of a line printer as the example of the image forming apparatus according to the present invention.

The line printer (hereinafter referred to as a “printer”) 10 includes printing heads K1, K2, K3 and K4 for forming an image by ejecting ink on each of multiple labels 14 (constituting an example of printing media), The labels 14 are tentatively adhered to a surface of a rolled board 12. The printing heads K1, K2, K3 and K4 are held still, and never move, while forming an image. Black ink droplets are ejected from each of the printing heads K1 to K4. Together with the board 12, the labels 14 are conveyed at a constant speed in the arrow A direction by conveyance rollers 18 and 20 driven by a conveyance motor 16.

An ink ejection opening array is formed in each of the printing heads K1, K2, K3 and K4. The ink ejection opening array comprises multiple ink ejection openings arranged in a direction orthogonal to the printing medium conveying direction (the orthogonal direction constitutes an example of the intersection direction as the recited in the present invention). In this case, an image is formed by use of the four printing heads K1, K2, K3 and K4 (corresponding to the four ink ejection opening arrays, and constituting an example of the multiple array arrangement as recited in the present invention) arranged one after another in the printing medium conveying direction (or in the arrow A direction).

A front end detecting sensor 22 for detecting the front end of each label 14 is arranged in a location upstream of the printing head K1 in the conveyance direction (or upstream of the printing head K1 in the arrow A direction). Each time the front end detecting sensor 22 detects the front end of a label 14, the printing heads K1, K2, K3 and K4 start to eject ink at their respective predetermined timings, and thus start to sequentially perform printing on the label 14. In addition, another front end detecting sensor 24 for detecting the front end of a label 14 is arranged in a location downstream of the printing head K4 in the conveyance direction (downstream of the printing head K4 in the arrow A direction). This front end detecting sensor 24 is used to detect a jam.

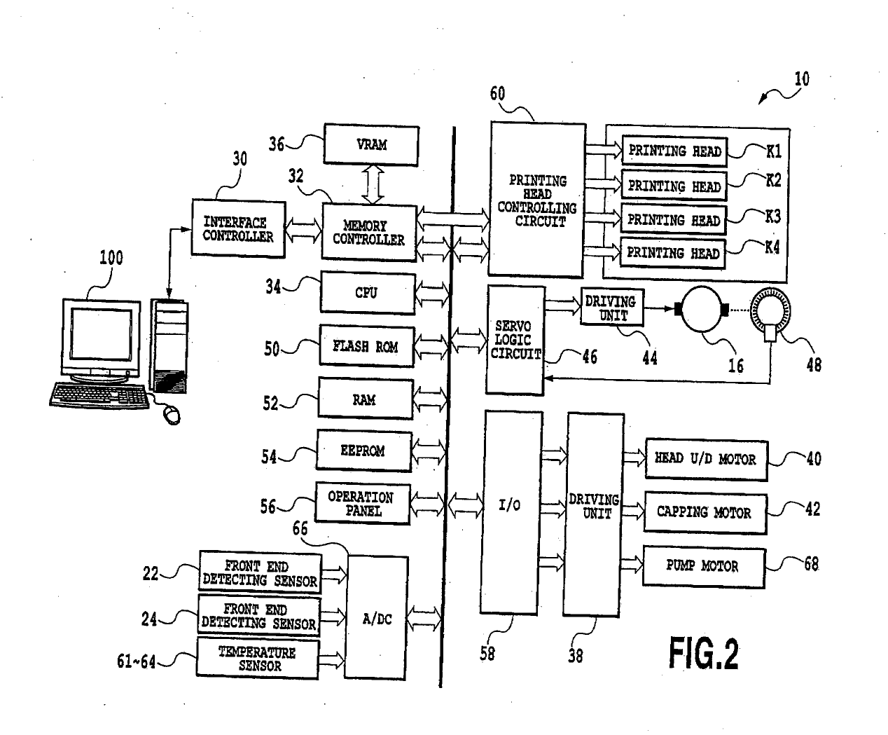

Referring to FIG. 2, descriptions will be provided for a control system of the printer 10 shown in FIG. 1.

FIG. 2 is a block diagram showing an example of a configuration of the control system of the printer shown in FIG. 1.

Data on an image to be formed on the labels 14 on the board 12 (see FIG. 1) is created by use of a personal computer as a host apparatus (hereinafter referred to as a “host PC”) 100. The image data thus created is transferred to an interface controller 30, and thereafter is transmitted to a memory controller 32 from the interface controller 30. In accordance with a CPU 34 (constituting an example of a basic assignment changing unit and an example of a basic assignment storage unit as recited in the present invention, and simultaneously constituting an example of a number-of-dots detecting unit as recited in the present invention), the memory controller 32 temporarily writes the received data (or the image data) in a VRAM 36 at high speed. Once a predetermined amount of printing data is written in the VRAM 36, the CPU 34 starts to prepare each of the printing heads K1 to K4 to perform an operation for forming an image.

First of all, the CPU 34 causes a head up/down motor 40 and a capping motor 42 to operate in a mutually cooperative manner. Thus, the printing heads K1 to K4 which have been in a standby mode while capped by a capping mechanism (not illustrated) are moved to their printing positions. When the printing heads K1 to K4 are moved thereto, the printing heads K1 to K4 move in a vertical direction, and the capping mechanism (not illustrated) moves in a direction parallel to the conveyance direction (or in the arrow A direction shown in FIG. 1). Subsequently, the CPU 34 causes a driving unit 44 to drive a conveyance motor 16, and thus starts to convey the board 12. The activation of the conveyance motor 16 is triggered by the writing of a value representing an instruction on the speed of conveyance motor 16 in a servo logic circuit 46 by the CPU 34.

Thereafter, the output of the rotary encoder 48 is fed back to the servo logic circuit 46. The speed at which the board 12 is conveyed is controlled by a feedback controlling system comprising the driving unit 44, the conveyance motor 16, the rotary encoder 48 and the servo logic circuit 46 in such a way as to ensure that the conveyance speed is kept constant.

The servo logic circuit 46 converts the output from the rotary encoder 48 to a pulse representing the position in which the board 12 is being conveyed (hereinafter referred to as a “conveyance position pulse), and outputs the resultant pulse. This outputted data is used as a cue signal for the printing heads K1 to K4 to begin performing their respective raster printing.

Once the front end detecting sensor 22 detects the front end of a label 14, a printing head controlling circuit 48 receives conveyance position pulses corresponding to the distances between this front end detecting sensor 22 and the printing heads K1 to K4, respectively. In addition, the CPU 34 starts to read contents of an image buffer in the memory controller 32, and transfers the thus-read image buffer contents to the printing head controlling circuit 48. The printing head controlling circuit 48 generates sets of printing data for the respective printing heads K1 to K4. The sets of printing data include their respective cue timings which are different among the printing heads K1 to K4. The whole raster is covered by these sets of printing data. At this time, in the printing head controlling circuit 48, a transfer/output section assigned to the printing head K1 masks sets of printing data that correspond to rasters (three rasters out of the four rasters) of which the printing head K1 is not in charge; a transfer/output section assigned to the printing head K2 masks sets of printing data that correspond to rasters (three rasters out of the four rasters) of which the printing head K2 is not in charge; a transfer/output section assigned to the printing head K3 masks sets of printing data that correspond to rasters (three rasters out of the four rasters) of which the printing head K3 is not in charge; and a transfer/output section assigned to the printing head K4 masks sets of printing data that correspond to rasters (three rasters out of the four rasters) of which the printing head K4 is not in charge.

The process which the CPU 34 carries out depends on a control program written in a Flash ROM 50 (constituting an example of a storage as recited in the present invention). In addition, a RAM 52 is used to store temporary working files. An EEPROM 54 is a non-volatile memory in which numeric values inherent to the apparatus are stored. Examples of the numeric values inherent to the apparatus include adjustment values for electrically adjusting fine mutual printing positions (registrations) of the printing heads K1 to K4. Furthermore, the printer 10 is provided with an operation panel 56 including LCD indicators, other type indicators, as well as keys for pausing, resuming and emergently stopping a printing operation. The operation panel is configured to be capable of writing display data and reading the ON/OFF condition of each key, through an input/output port 58.

The printing heads K1 to K4 include built-in temperature sensors 61 to 64 (constituting an example of temperature detecting units as recited in the present invention) for detecting the temperatures of the ink ejection opening arrays formed in the printing heads K1 to K4, respectively. Output analog values representing the temperatures detected by the temperature sensors 61 to 64 as well as output analog values representing detection signals detected by the front end detecting sensors 22 and 24 are read through an AD converter 66 almost in real time. A pump motor 68 drives a pump (not illustrated) used when ink is supplied to the printing heads K1 to K4 from an ink tank (not illustrated), or when a normal printing performance is recovered by forcedly discharging ink from the ink ejection openings through pressurizing the insides of the printing heads K1 to K4.

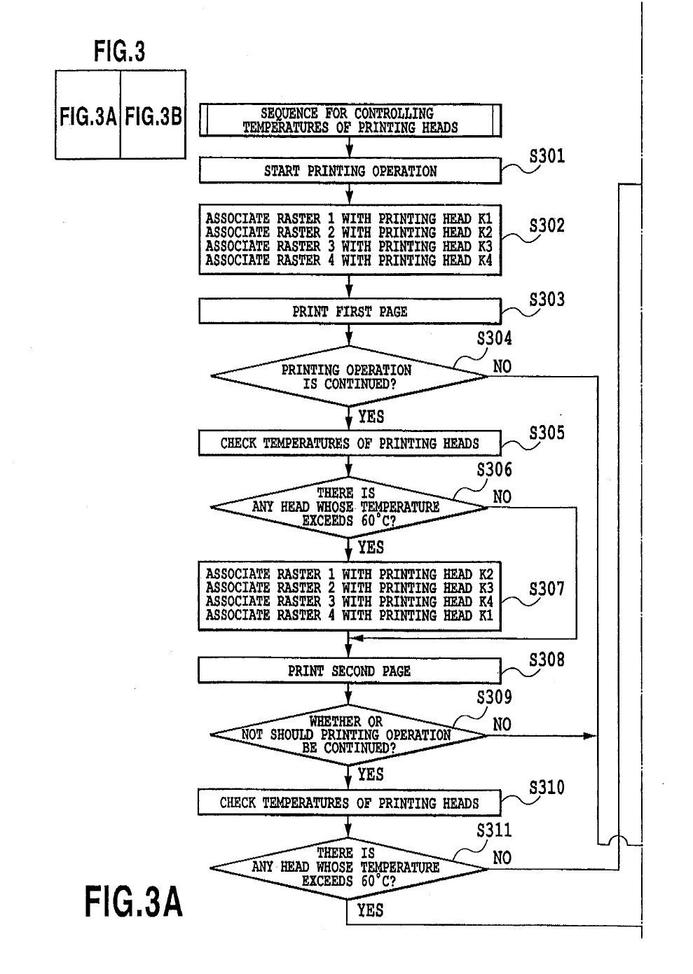

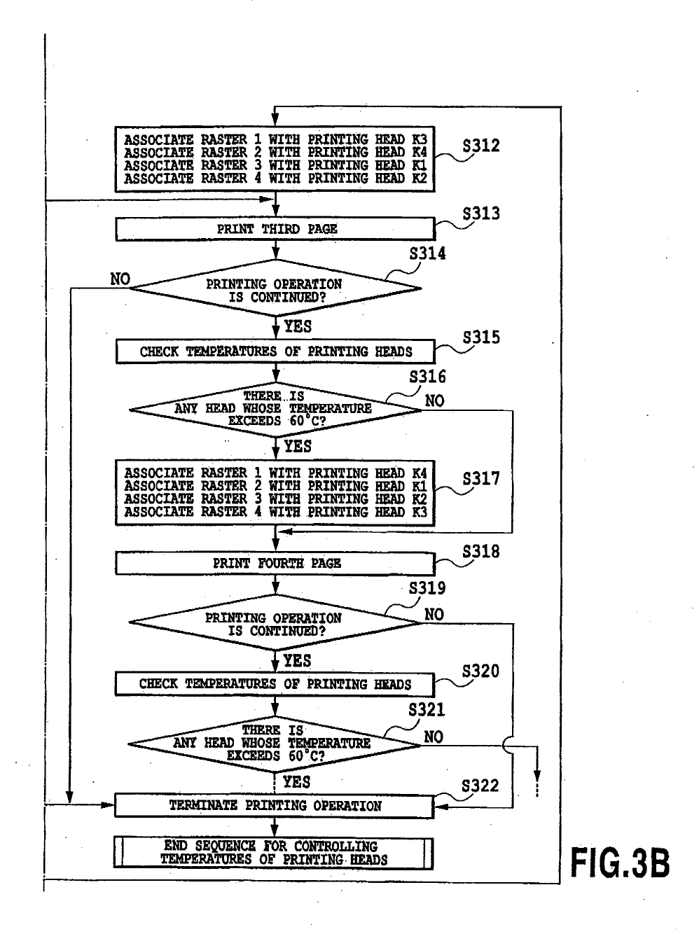

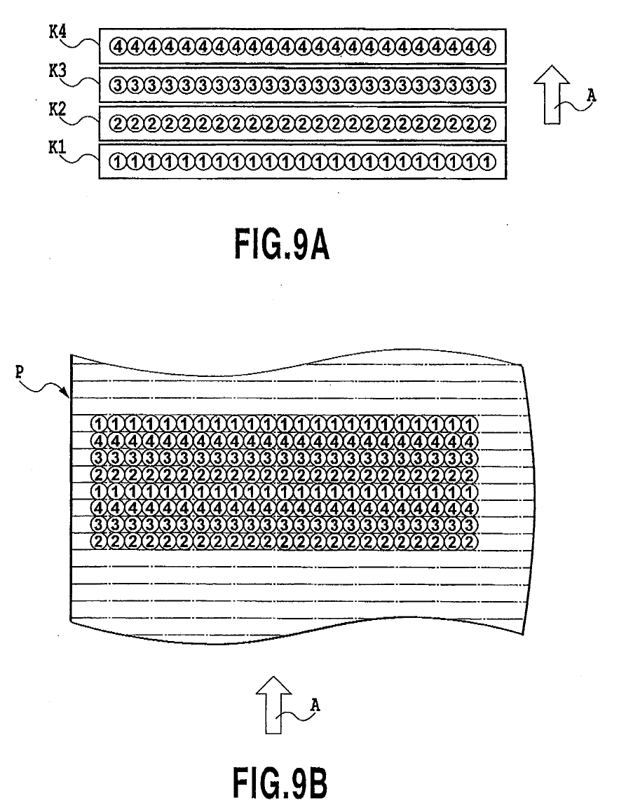

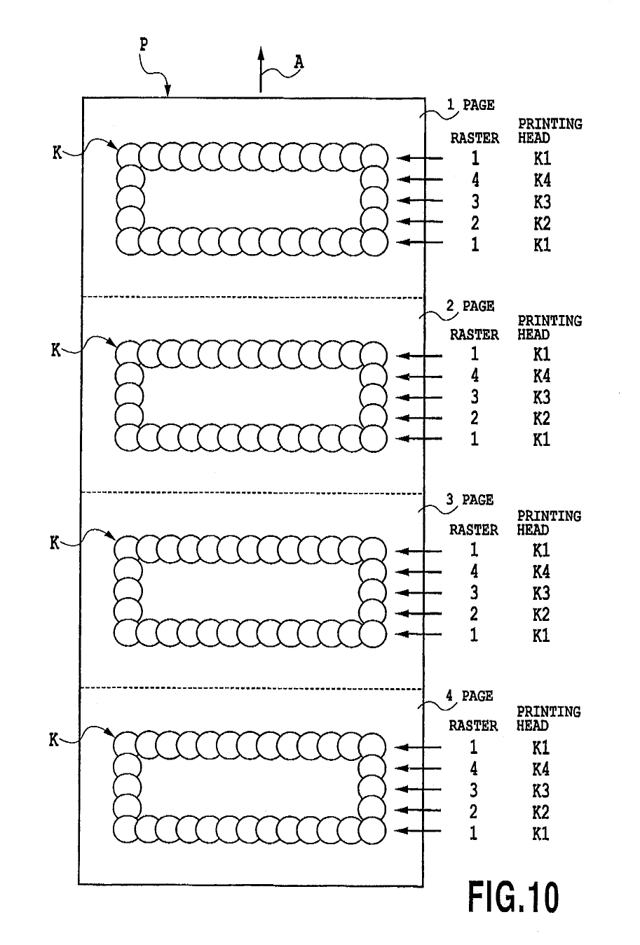

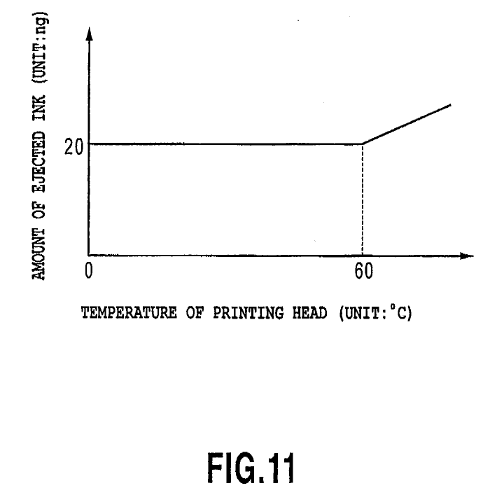

Referring to FIGS. 3A and 3B, descriptions will be provided for an image forming method using the printer 10 with the foregoing configuration. FIGS. 3A and 3B show a flowchart showing the first embodiment of the image forming method according to the present invention. In this respect, the basic assignment is that, as shown in FIG. 9, the rasters 1, 2, 3 and 4 are associated with the printing heads K1, K2, K3 and K4, respectively.

The flow shown in FIG. 3 is that for the image forming method of a type with which the basic assignment is changed when any one of the temperatures detected by the temperature sensors 61 to 64 (see FIG. 2) exceeds a predetermined temperature (60° C. in this case). Specifically, each time the printing heads K1 to K4 finish forming an image on a printing medium (a label 14 in this case), the temperatures of the printing heads K1 to K4 are detected by the temperature sensors 61 to 64, respectively. When any one of the temperatures thus detected exceeds 60° C., the association of the raster line regions with the ink ejection opening arrays under the basic assignment (the association of the rasters 1 to 4 with the printing heads K1 to K4) is shifted one-by-one.

This flow is activated when a signal representing the start of a printing operation is inputted from the host PC 100 (see FIG. 2) to the CPU 34 (in step S301). In accordance with a program and the like stored in the Flash ROM 50 (see FIG. 2), the CPU 34 executes this flow. First of all, data received from the host PC 100 (see FIG. 2) is divided into data units corresponding to the rasters 1 to 4. Thus, the data units corresponding to the rasters 1 to 4 to the printing heads K1 to K4 are assigned (in step S302). This assignment is the basic assignment. How to execute the basic assignment is beforehand stored in the Flash ROM 50. Subsequently, the first page is printed (in step S303). Thereafter, it is determined whether or not the printing operation should be continued (whether or not there is a second page to be printed) (in step S304). When the printing operation should not be continued, the printing operation is terminated (in step S322). When the printing operation should be continued, the temperatures of the printing heads K1 to K4 are detected by using the temperature sensors 61 to 64, respectively (in step S305). Hence, it is determined whether or not the temperatures thus detected exceed 60° C. (in step S306). When all the temperature sensors 61 to 64 detect the temperatures which are lower than 60° C., the second page is printed (in step S308). When any one of the temperatures detected by the temperature sensors 61 to 64 exceeds 60° C., the raster assignment is shifted one-by-one (the association of the rasters 1 to 4 to the printing heads K1 to K4 is shifted on-by-one) (in step S307). Specifically, the rasters 1, 2, 3 and 4 are associated with the printing heads K2, K3, K4 and K1, respectively. In other words, ink is ejected from the printing head K1 onto the raster line region 1 under the basic assignment, whereas ink is ejected from the printing head K2 onto the raster line region 1 after the assignment is changed. Similarly, ink is ejected from the printing head K2 onto the raster line region 2 under the basic assignment, whereas ink is ejected from the printing head K3 onto the raster line region 2 after the assignment is changed. Similarly, ink is ejected from the printing head K3 onto the raster line region 3 under the basic assignment, wherein ink is ejected from the printing head K4 onto the raster line region 3 after the assignment is changed. Similarly, ink is ejected from the printing head K4 onto the raster line region 4 under the basic assignment, wherein ink is ejected from the printing head K1 onto the raster line region 4 after the assignment is changed. This change in the basic assignment makes it possible to decrease the amount of ink to be ejected from a printing head whose temperature is higher than the predetermined temperature, and accordingly to prevent the temperature of the printing head from continuing to be higher than the predetermined temperature.

As described above, when the temperatures of the printing heads K1 to K4 are detected after the first page is printed, it is possible to decrease the amount of ink to be ejected (or to stop ink from being ejected) from any printing head whose temperature exceeds the predetermined temperature. This makes it possible to decrease the printing head's temperature which exceeds the predetermined temperature. This decrease makes it possible to prevent the image quality from deteriorating due to the increase in the temperature of the printing head, and accordingly to keep the printing quality stable. In a case where, for example, the temperatures of the printing heads K1 and K2 are both detected exceeding 60° C. in step S306, the assignment change in step S307 cannot decrease the temperature of the printing head K2. However, because, in step S311, the CPU 34 makes the same detection as is made in step S306, the temperature rise of the printing head K2 is suppressed.

In step S307, the raster assignment is shifted one-by-one. Thereafter, the second page is printed (in step S308). After this printing operation, like in step S304, it is determined whether or not the printing operation should be continued (whether or not there is a third page to be printed) (in step S309). When the printing operation should not be continued, the printing operation is terminated (in step S322). When the printing operation should be continued, the temperatures of the printing heads K1 to K4 are detected by using the temperature sensors 61 to 64, respectively (in step S310). Hence, it is determined whether or not the temperatures thus detected exceed 60° C. (in step S311). When all the temperature sensors 61 to 64 detect the temperatures which are lower than 60° C., the third page is printed (in step S313). When any one of the temperatures detected by the temperature sensors 61 to 64 exceeds 60° C., the raster assignment is shifted one-by-one (the association of the rasters 1 to 4 to the printing heads K1 to K4 is shifted on-by-one) again (in step S312). Specifically, the rasters 1, 2, 3 and 4 are associated with the printing heads K3, k4, k1 and k2, respectively. In other words, ink is ejected from the printing head K1 onto the raster line region 1 under the basic assignment, whereas ink is ejected from the printing head K3 onto the raster line region 1 after the second assignment change. Similarly, ink is ejected from the printing head K2 onto the raster line region 2 under the basic assignment, whereas ink is ejected from the printing head K4 onto the raster line region 2 after the second assignment change. Similarly, ink is ejected from the printing head K3 onto the raster line region 3 under the basic assignment, wherein ink is ejected from the printing head K1 onto the raster line region 3 after the second assignment change. Similarly, ink is ejected from the printing head K4 onto the raster line region 4 under the basic assignment, wherein ink is ejected from the printing head K2 onto the raster line region 4 after the second assignment change. This change in the basic assignment makes it possible to decrease the amount of ink to be ejected from a printing head whose temperature is higher than the predetermined temperature, and accordingly to prevent the temperature of the printing head from continuing to be higher than the predetermined temperature.

In step S312, the raster assignment is shifted one-by-one. Thereafter, the third page is printed (in step S313). After this printing operation, it is determined whether or not the printing operation should be continued (whether or not there is a fourth page to be printed) (in step S314). When the printing operation should not be continued, the printing operation is terminated (in step S322). When t the printing operation should be continued, the temperatures of the printing heads K1 to K4 are detected by the temperature sensors 61 to 64, respectively (in step S315). Hence, it is determined whether or not the temperatures thus detected exceed 60° C. (in step S316). When all the temperature sensors 61 to 64 detect the temperatures which are lower than 60° C., the fourth page is printed (in step S318). When any one of the temperatures detected by the temperature sensors 61 to 64 exceeds 60° C., the raster assignment is shifted one-by-one (the association of the rasters 1 to 4 to the printing heads K1 to K4 is shifted on-by-one) once again (in step S317). Specifically, the rasters 1, 2, 3, and 4 are associated with the printing heads K4, K1, K2, and K3, respectively. In other words, ink is ejected from the printing head K1 onto the raster line region 1 under the basic assignment, whereas ink is ejected from the printing head K4 onto the raster line region 1 after the third assignment change. Similarly, ink is ejected from the printing head K2 onto the raster line region 2 under the basic assignment, whereas ink is ejected from the printing head K1 onto the raster line region 2 after the third assignment change. Similarly, ink is ejected from the printing head K3 onto the raster line region 3 under the basic assignment, wherein ink is ejected from the printing head K2 onto the raster line region 3 after the third assignment change. Similarly, ink is ejected from the printing head K4 onto the raster line region 4 under the basic assignment, wherein ink is ejected from the printing head K3 onto the raster line region 4 after the third assignment change. This change in the basic assignment makes it possible to decrease the amount of ink to be ejected from a printing head whose temperature is higher than the predetermined temperature, and accordingly to prevent the temperature of the printing head from continuing to be higher than the predetermined temperature.

In step S317, the raster assignment is shifted one-by-one. Thereafter, the fourth page is printed (in step S318). After this printing operation, it is determines whether or not the printing operation should be continued (whether or not there is a fifth page to be printed) (in step S319). When the printing operation should not be continued, the printing operation is terminated (in step S322). When the printing operation should be continued, the temperatures of the printing heads K1 to K4 are detected by the temperature sensors 61 to 64, respectively (in step S320). Hence, it is determined whether or not the temperatures thus detected exceed 60° C. (in step S321). When all the temperature sensors 61 to 64 detect the temperatures which are lower than 60° C., the fifth page is printed (in a step not illustrated). When any one of the temperatures detected by the temperature sensors 61 to 64 exceeds 60° C., the raster assignment is shifted one-by-one (the association of the rasters 1 to 4 to the printing heads K1 to K4 is shifted on-by-one) once again (in a step not illustrated). In this case, the raster assignment returns to the basic assignment (the same assignment as is applied in step S302).

By, as described above, shifting the raster assignment each time the temperature of one of the printing head exceeds the certain temperature, it is possible to avoid any specific printing head being used overwhelming more than the other printing heads, and thus to make the temperatures of the respective printing heads equal to each other, as well as accordingly to cause the printing heads to eject the same amount of ink.

### Second Embodiment

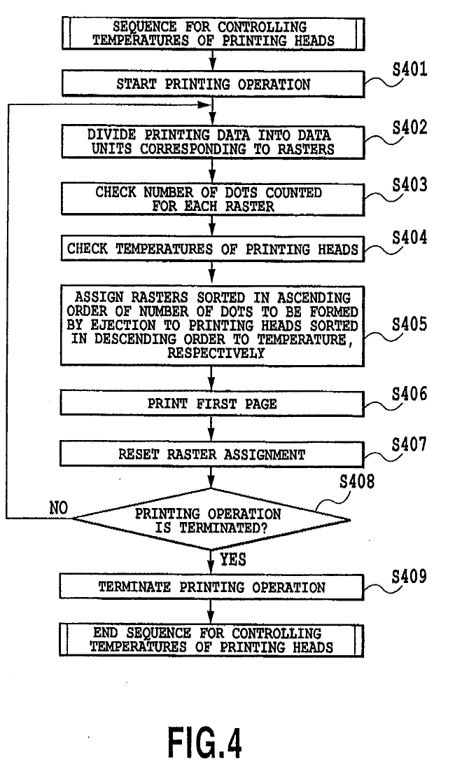

Referring to FIG. 4, descriptions will be provided for another example of the image forming method using the printer 10 with the foregoing configuration. FIG. 4 is a flowchart showing a second embodiment of the image forming method according to the present invention. In this respect, the basic assignment is that, as shown in FIG. 9, the rasters 1, 2, 3, and 4 are associated with the printing heads K1, K2, K3, and K4, respectively.

The flow shown in FIG. 4 is that for the image forming method of a type with which the number of dots to be ejected from each of the printing heads K1 to K4 is detected before an image is formed on a printing medium (a label 14 in this case), and with which the basic assignment is thus changed on the basis of the detected number of dots to be ejected from each of the printing heads K1 to K4. Specifically, the raster assignment is arbitrarily changed for each page. A printing head whose temperature is the lowest is assigned to a raster which needs the largest number of dots to be ejected in a page. By contrast, a raster which needs the smallest number of dots to be ejected in the page is assigned to a printing head whose temperature is the highest. This makes it possible to suppress the temperature rise of each of the printing heads.

This flow is activated when a signal representing the start of a printing operation is inputted from the host PC 100 (see FIG. 2) to the CPU 34 (in step S401). In accordance with a program and the like stored in the Flash ROM 50 (see FIG. 2), the CPU 34 executes this flow. First of all, data received from the host PC 100 (see FIG. 2) is divided into data units corresponding to the rasters 1 to 4. Thus, the data units corresponding to the rasters 1 to 4 to the printing heads K1 to K4 are assigned (in step S402). This assignment is the basic assignment. How to execute the basic assignment is beforehand stored in the Flash ROM 50. Subsequently, the CPU 34 counts the number of dots needed to be ejected for each of the rasters (in step S403). Specifically, before the first page is printed, the number of ink droplets needed to be ejected from (the ink ejection opening array in) each of the printing heads K1 to K4 is calculated (found) for each of the printing heads K1 to K4. Subsequently, the temperatures of the printing heads K1 to K4 are detected by the temperature sensors 61 to 64 (see FIG. 2), respectively (in step S404). The rasters sorted in ascending order of the number of dots thus counted are assigned to the printing heads sorted in descending order to the temperature, respectively (in step S405). Thereafter, the first page is printed (in step S406).

After the first page is printed, the raster assignment used in step S405 is reset (in step 407). Subsequently, it is determined whether or not there is a second page to be printed (in step S408). When there is no second page, the printing operation is terminated (in step S409). When there is a second page to be printed, by returning to step S402, for each of the printing heads K1 to K4. CPU 34 calculates the number of ink droplets ejected from (the ink ejection opening array in) each of the printing heads K1 to K4 while the second page is being printed (in step S403). Thereafter, the same procedure is repeated until the printing operation is completed.

As described above, which ink ejection opening array out of the multiple ink ejection opening arrays is beforehand assigned to which raster line region out of the multiple raster line regions on a printing medium. Thereby, the basic assignment is set up. On the other hand, before an image is formed on the printing medium, the number of dots to be formed by ink ejected from each of the multiple of ink ejection opening arrays is detected. On the basis of the detected number of dots to be formed by ink ejected from each of the multiple of ink ejection opening arrays, and on the basis of the temperatures of the respective printing heads, the basic assignment is changed. For this reason, it is possible to avoid a specific printing head being used overwhelming more than the other printing heads, and thus to makes the temperatures of the respective printing heads equal to each other, as well as accordingly to cause the printing heads to eject the same amount of ink. This makes it possible to keep the printing quality stable.

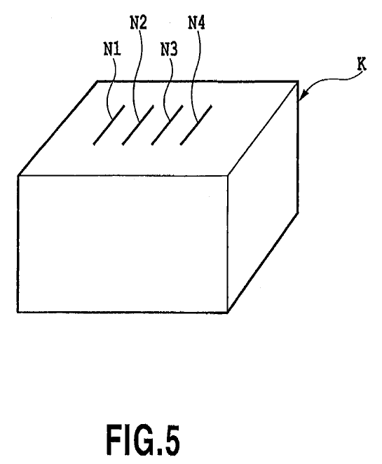

The foregoing embodiments have shown the case where a single ink ejection opening array is formed in each of the printing heads. Nevertheless, the present invention is applicable to a case where, as shown in FIG. 5, multiple ink ejection opening arrays (nozzle arrays) N1, N2, N3 and N4 are formed in a single printing head.

### Third Embodiment

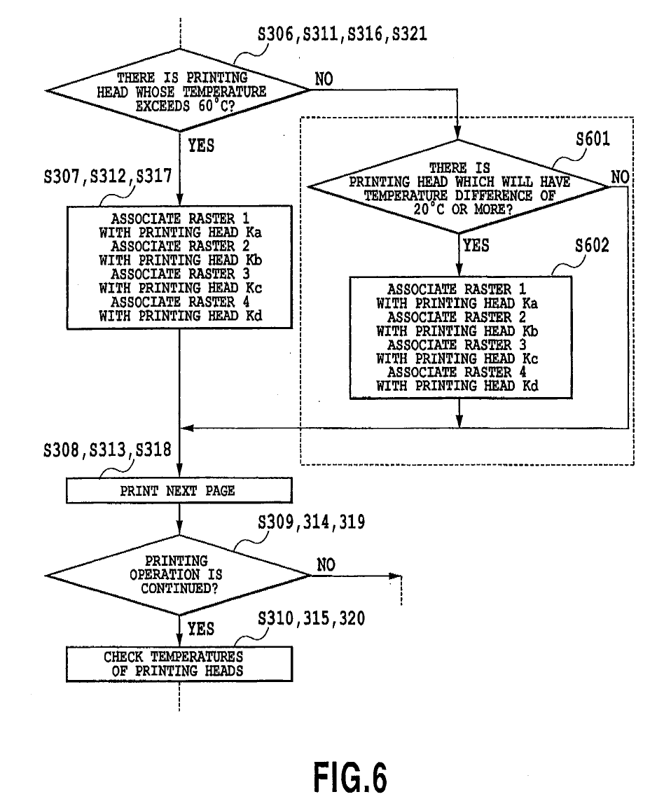

Referring to FIG. 6, descriptions will be provided for a third embodiment of the present invention.

FIG. 6 is a flowchart showing the third embodiment of the image forming method according to the present invention. The flow shown in FIG. 6 is the same as the flow shown in FIG. 3 except that the flow shown in FIG. 6 includes steps obtained by modifying a part of the flowchart shown in FIG. 3. The steps obtained by modifying the part of the flowchart shown in FIG. 3 are indicated by broken lines in FIG. 6. Because the procedure preceding and ensuing the steps obtained by the modification is the same as the procedure shown in FIG. 3, a part of the procedure is omitted from FIG. 6. The procedure shown in FIG. 6 is made up by adding steps S601 and S602 to the procedure shown in FIG. 3 in a way that steps S601 and S602 come after the branch “N” in steps S306, S311, S316 and 5321.

In the first embodiment, only whether or not the highest one among the temperatures of the respective printing heads K1 to K4 exceeds 60° C. is taken into consideration in steps S306, S311, S316 and S321. In addition, the difference between the highest and lowest ones among the temperatures of the respective printing heads K1 to K4 may be taken into consideration. In this case, when the difference exceeds a predetermined value, the basic assignment may be changed. The reason for this is as follows. Even in a case where the highest temperature does not exceed 60° C. yet, when the difference between the highest and lowest ones among the temperatures of the respective printing heads exceeds 20° C., if the highest temperature is waited for to exceed 60° C., it takes a long time for the difference to become small even though the raster assignment is changed. With this taken into consideration, even though the highest temperature does not exceed 60° C., when the difference between the highest and lowest ones among the temperatures of the respective printing heads K1 to K4 exceeds a predetermined value (20° C. in the present embodiment) which is determined by the printing heads, the raster assignment is changed. This makes it possible to prevent a specific printing head from having outstandingly the highest temperature, and thus to make the temperatures of the respective printing heads equal to each other. Referring to FIG. 6, descriptions will be provided for the procedure. As described above, the procedure shown in FIG. 6 is different from the procedure shown FIG. 3 in terms of the steps indicated by the broken lines.

The uppermost part of the procedure shown in FIG. 6 is the determination on whether or not the highest temperature exceeds 60° C. in steps S306, S311, S316 and S321. Reference numeral Ka, Kb, Kc and Kd denotes arbitrary printing heads. If “YES” in step S306, S311, S316 and S321, performed is an operation which is the same as the operation included in the flowchart (see FIG. 3) according to the first embodiment. By contrast, if “NO” in step S306, S311, S316 and S321, the steps indicated by the broken lines are additionally performed. Specifically, it is determined whether or not the difference between the highest and lowest ones among the temperatures of the respective printing heads exceeds 20° C. (in step S601). If “NO”, performed is a step which is the same as the step included in the flow shown in FIG. 3 (for example, proceeds to S307). By contrast, if “YES” in step S601, the basic assignment is changed. This change makes it possible to decrease the amount of ink to be ejected from a printing head whose temperature is the highest, and thus to prevent the temperature of this printing head from rising to exceed 60° C.

### Fourth Embodiment

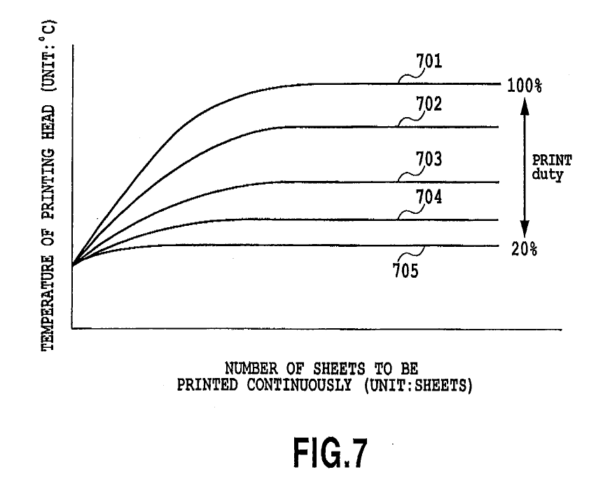

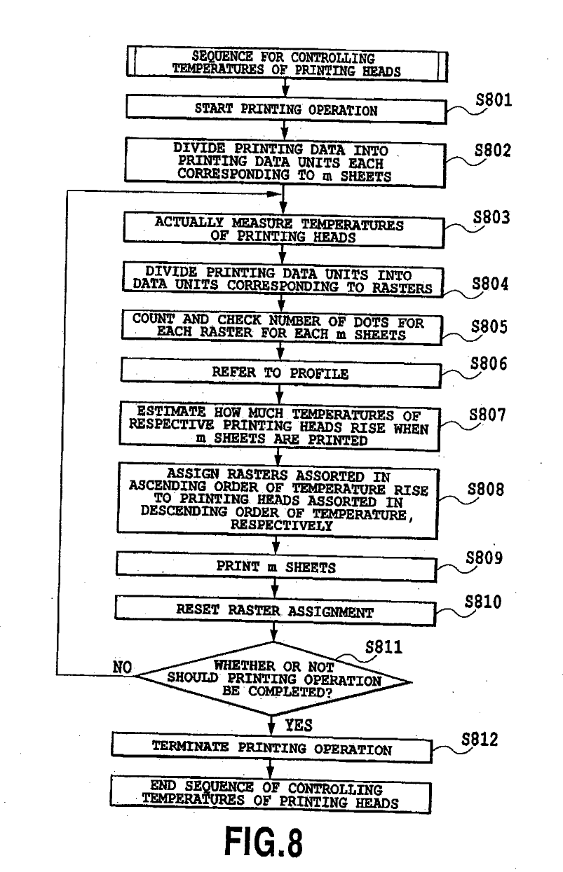

In the first to third embodiments, the temperatures of the respective printing heads are measured (actually measured) each time a printing operation is completed, and the basic assignment is changed on the basis of the temperatures thus measured. As to a fourth embodiment, descriptions will be provided for a case where, on the basis of printing data (image data), it is estimated how much the temperatures of the respective printing heads will increase (what temperatures of the respective printing heads will have each time a printing operation is completed), and where the basic assignment is changed on the basis of the temperatures thus estimated. Referring to FIGS. 7 and 8, descriptions will be provided for the fourth embodiment.

FIG. 7 is a graph showing how the temperature of the printing head rises depending on the number of sheets to be printed continuously (as the number of sheets to be printed continuously increases). In FIG. 7, the horizontal axis indicates the number of sheets to be printed continuously, and the vertical axis indicates how many degrees of the temperature rise in the printing head. FIG. 8 is a flowchart showing the fourth embodiment of the image forming method. The curves 701, 702, 703, 704 and 705 shown in FIG. 7 indicate how differently the temperature of the printing head rises when an ink application amount (the amounts of ink ejected and the printing duties) varies even when continuously printing the same numbers of sheets. The curves prove that the temperature of the printing head becomes higher as the ink application amount increases (the printing duty becomes heavier).

In the flow shown in FIG. 8, the number of dots to be formed by ejected ink is beforehand calculated for each raster on the basis of the printing data before an image is formed on a printing medium (for example, a label 14 (see FIG. 1)); on the basis of the number of dots calculated for each raster, the ink application amounts (the ink ejection amount) is beforehand calculated for each raster; referring to the graph shown in FIG. 7, the temperatures of the printing heads (the head temperatures) are estimated; and on the basis of the head temperatures thus estimated, the basic assignment is changed in order to prevent the head temperatures from rising (to prevent the head temperatures from exceeding a certain temperature). Specifically, before a certain number of sheets (m sheets) are printed, the basic assignment is changed in a way that a printing head whose temperature is the lowest before a printing operation is assigned to one of the rasters which is estimated to cause the temperature of the printing head to become the highest (after the printing of the m sheets), the raster whose printing duty being estimated to be the heaviest among the rasters when the m sheets are printed. To put it the other way around, when a certain number of sheets (m sheets) start to be printed, a raster whose printing duty to print the m sheets is the lightest is assigned to a printing head whose temperature is estimated to become the highest (after the m sheets are printed). This scheme makes it possible to prevent the temperatures of the respective printing heads from continuing to rise.

The flow shown in FIG. 8 is activated when a signal representing the start of a printing operation is inputted from the host PC 100 (see FIG. 2) to the CPU 34 (in step S801). In accordance with a program and the like stored in the Flash ROM 50 (see FIG. 2), the CPU 34 executes this flow. First of all, printing data (image data) received from the host PC 100 (see FIG. 2) are divided into printing data units each corresponding to the certain number of sheets (the certain m sheets) (in step S802). Subsequently, the temperatures of the respective printing heads K1 to K4 are measured (actually measured) (in step S803). Thereafter, printing data unit corresponding to the certain number of sheets is divided into data units corresponding to the rasters (in step S804).

Subsequently, the number of dots is counted (the printing duty is calculated) for each of the divided rasters (in the case of the rasters 1 to 4) (in step S805). In other words, before the certain number of sheets is printed, the number of ink droplets to be ejected onto each of the rasters 1 to 4 when the certain number of sheets are printed is beforehand calculated (found) for each of the rasters 1 to 4. Thereafter, a profile (corresponding to the graph shown in FIG. 7) stored in the Flash ROM 50 (see FIG. 2) is referred (in step S806). Thus, how much the temperatures of the printing heads will rise after an image corresponding to each of the rasters 1 to 4 is formed (in step S807) is estimated. Referring to the temperatures of the printing heads K1 to K4 measured in step S803, determined is which one out of the rasters 1 to 4 should be assigned to which one out of the printing heads K1 to K4. In this respect, a raster which is estimated in step S807 to raise the temperature of a printing head least (a raster whose printing duty is the lightest) is assigned to a printing head whose measured temperature is the highest in step S803. In other words, a raster which is estimated to raise the temperature of a printing head least when an image formation corresponding to the raster is completed is assigned to a printing head whose measured temperature is the highest in step S803. Similarly, a raster whose printing duty is the second lightest is assigned to a printing head whose measured temperature is the second highest in step S803. Similarly, a raster whose printing duty is the third lightest is assigned to a printing head whose measured temperature is the third highest in step S803. Similarly, a raster whose printing duty is the heaviest is assigned to a printing head whose measured temperature is the lowest in step S803 (in step S808). The combination of the rasters with the printing heads resulting from the first assignment of the rasters to the respective printing heads constitutes the basic assignment in step S808. By assigning the rasters 1 to 4 to the printing heads K1 to K4 in this manner, the certain number of sheets is printed (in step S809).

After the certain number of sheets is printed in step S809, the raster assignment executed in step S808 is reset (in step S810). After that, it is determined whether or not there is another printing operation to be performed (in step S811). When there is no printing operation to be performed, the printing operation is terminated (in step S812). When there is another printing operation to be performed, by returning to step S803, the temperatures of the printing heads K1 to K4 are measured. Thereafter, at step S804, printing data unit corresponding to the next m sheets is divided into data units corresponding to the rasters. Subsequently, the same procedure is repeated until the printing operation is completed.

The foregoing embodiments have shown the case of the raster division using the multiple printing heads. Nevertheless, the present invention is applicable to a single head which includes, as shown in FIG. 5, multiple ink ejection opening arrays (nozzle arrays) N1, N2, N3 and N4 handling ink of a single and common color.

The image forming method according to the fourth embodiment is capable of changing the basic assignment in order that, before the image is formed, a raster which is estimated to raise the temperature of a printing head least when the image is formed can be assigned to a printing head whose temperature is the highest. As a result, the image forming method is capable of checking the extent that the temperatures of the respective printing heads continue rising. For this reason, the image forming method is capable of reducing the deterioration in the image quality which occurs due to an increase of the temperatures of the respective printing heads.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application Nos. 2007-223880, filed Aug. 30, 2007 and 2008-176711, filed Jul. 7, 2008 which are hereby incorporated by reference herein in their entirety.

What is claimed is:

1. An image forming method of forming an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being affanged one after another in the printing medium conveying direction, each ink ejection opening array including a plurality of ink ejection openings arranged in the intersection direction, comprising the steps of:
setting up a basic assignment beforehand determining which one of the plurality of ink ejection opening arrays is to be assigned to each of the raster line regions on the printing medium so that the ink is ejected from the assigned ink ejection opening away to the assigned raster line region;
detecting temperatures respectively of the plurality of ink ejection opening arrays while the image is being formed; and
based on the temperatures thus detected, changing the basic assignment.

2. An image forming method as claimed in claim 1, wherein the basic assignment is changed when any one of the temperatures thus detected exceeds a predetermined temperature.

3. An image forming method as claimed in claim 1, wherein the basic assignment is changed when the difference between the highest and lowest temperatures of the thus-detected temperatures of the ink ejection opening arrays exceeds a predetermined temperature.

4. An image forming method as claimed in claim 1, wherein the basic assignment is changed each time the forming of the image on a printing medium is completed.

5. An image forming method as claimed in claim 1, wherein the basic assignment is changed by shifting the association of the raster line regions with the ink ejection opening arrays one-by-one each time the forming of the image on a printing medium is completed.

6. An image forming method as claimed in claim 1, further comprising the step of:
before the image is formed on the printing medium, detecting the number of dots to be formed by ink ejected from each of the ink ejection opening arrays,
wherein the basic assignment is changed further based on the number of dots detected to be formed.

7. An image forming apparatus that forms an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being arranged one after another in the printing medium conveying direction, each ink ejection opening array including a plurality of ink ejection openings arranged in the intersection direction, comprising:
a setting up unit which sets up a basic assignment beforehand determining which one of the plurality of ink ejection opening arrays is to be assigned to each of the raster line regions on the printing medium so that the ink is ejected from the assigned ink ejection opening array to the assigned raster line region;
a detecting unit which detects temperatures respectively of the plurality of ink ejection opening arrays while the image is being formed; and
a basic assignment changing unit which changes the basic assignment based on the temperatures detected by the detection unit.

8. An image forming apparatus as claimed in claim 7, wherein the basic assignment changing unit changes the basic assignment when any one of the temperatures thus detected exceeds a predetermined temperature.

9. An image forming apparatus as claimed in claim 7, wherein the basic assignment changing unit changes the basic assignment when the difference between the highest and lowest temperatures of the thus-detected temperatures of the ink ejection opening arrays exceeds a predetermined temperature.

10. An image forming apparatus as claimed in claim 7, wherein the basic assignment changing unit changes the basic assignment each time the forming of the image on a printing medium is completed.

11. An image forming apparatus as claimed in claim 7, wherein the basic assignment changing unit changes the basic assignment by shifting the association of the raster line regions with the ink ejection opening arrays one-by-one each time the forming of the image on a printing medium is completed.

12. An image forming apparatus as claimed in claim 7, further comprising a the number-of dots detecting unit which detects the number of dots to be formed by ink ejected from each of the ink ejection opening arrays before the image is formed on the printing medium,
wherein the basic assignment changing unit changes the basic assignment further based on the number of dots detected by the number-of dots detecting unit.

13. An image forming method of forming an image on a printing medium by repeatedly ejecting ink onto each of raster line regions on the printing medium from any one of a plurality of ink ejection opening arrays, the raster line regions each including a plurality of pixel regions arranged in an intersection direction intersecting a printing medium conveying direction, each pixel region being that in which a pixel is formed, the plurality of ink ejection opening arrays being arranged one after another in the printing medium conveying direction, each ink ejection opening array including a plurality of ink ejection openings arranged in the intersection direction, comprising the steps of:
setting up a basic assignment beforehand determining which one of the plurality of ink ejection opening arrays be assigned to each of the raster line regions on the printing medium so that the ink is ejected from the assigned ink ejection opening array to the assigned raster line region;
estimating temperatures of the respective ink ejection opening arrays; and
based on the temperatures thus estimated, changing the basic assignment.

14. An image forming method as claimed in claim 13, further comprising the step of:
before the image is formed on the printing medium, detecting the number of dots to be formed by ink ejected from each of the ink ejection opening arrays,
wherein the basic assignment is changed further based on the number of dots detected to be formed.
